(19) United States
(12) Patent Application Publication
(10) Pub. No.: US 2016/0092948 A1
(43) Pub. Date: Mar. 31, 2016

(54) WIRELESS COMMUNICATION AND CONTROL SYSTEM FOR CHAIRS

(71) Applicants: William Nathan Sneller, Grand Rapids, MI (US); Paul Michael Sneller, Caledonia, MI (US)

(72) Inventors: William Nathan Sneller, Grand Rapids, MI (US); Paul Michael Sneller, Caledonia, MI (US)

(21) Appl. No.: 14/498,163

(22) Filed: Sep. 26, 2014

(51) Int. Cl. G06Q 30/06; G08C 17/02

(52) U.S. Cl. CPC G06Q 30/0601; G08C 17/02; G08C 2201/10

(57) ABSTRACT

A wireless communication and control method used to control functions of a chair and/or to facilitate commerce between an occupant of a chair and the operator of a facility. The system includes at least two devices in wireless communications. One being a chair based device capable of receiving and/or sending wireless signals, and may contain any or all of the following, a method for controlling functions of the chair, a method for accepting input from an occupant of the chair, a method for accepting payment, a method for receiving and displaying inputs from a remote operator or device. The second being a device capable of receiving and/or sending wireless signals, and may contain methods for accepting user input, displaying information conveyed by the operator of the first device, storing data, relaying data from the first device to any number of third devices.

### BACKGROUND OF THE INVENTION

This invention refers, in general, to theater, stadium, and other public seating chairs and a method to control said chairs via a remote device, to collect data from a person associated with one or more of said chairs, to communicate data to said person, and to provide goods and services for commercial or non-commercial reasons to said person.

A traditional movie theater experience consists of a relatively fixed theater seat and patrons having to exit, inconveniently, the theater in order to request service or goods from a server or concessions area. Many movie theaters are changing the traditional movie experience to incorporate reclining chairs to aid in the comfort of the movie going patron. Some theaters are offering restaurant style food in addition to traditional movie theater concessions which can be delivered to the patron before, during, or after the movie. The addition of reclining chairs and in-theater dining services produce inconveniences for the theater staff in cleaning the movie theater after a showing, preparing the theater for the next showing, and for communicating with the patron throughout the movie without becoming a distraction from the movie or disturbing other patrons.

In some instances it may be costly or inconvenient to run communications wires through the theater. In these instances it may be beneficial to install devices that do not need special wiring to facilitate action that may otherwise be executed using wired communications methods. A device which reduces these inconveniences may reduce cost, increase sales, and increase patron experience.

### SUMMARY OF THE INVENTION

The invention is a system or combination of systems containing multiple devices which allow the theater staff to reduce the labor required to clean and prepare the theater for the next showing and/or to reduce the labor and increase the quality of the experience by allowing a patron to request a visit from a server and/or to place an order specifically from a part of the invention embedded in the chair. Additionally, the invention saves labor and installation costs by allowing one or more devices to communicate with another device for controlling chairs or receiving information through wireless means forgoing the traditional method of running data cables to each and every chair, and providing a single device to communicate with many other devices.

In the simplest embodiment of this invention, two devices are required. The first device is substantially associated to an electrically reclining chair located in a movie theater and is comprised of a linear actuator, a microcontroller, an electrical control circuit suitable for controlling said linear actuator, a wireless communication module, and a device capable of providing adequate power for the necessary functions to be performed. In this particular embodiment the power supply used by the linear actuator is used to power the device, but any power supply is acceptable, including but not limited to a wall mounted transformer or a battery. The second device contains a microcontroller, a wireless communications module, a method for receiving an input from an outside entity, in this case a button, and a device capable of providing adequate power for the necessary functions to be performed. In this embodiment a small transformer, sometimes referred to as a “wall wart” is used, but any power supply is acceptable, especially a battery. The occupant of said chair may adjust the position of said linear actuator which controls the reclining mechanism using buttons which may or may not be a part of a claimed system. When the movie is complete and the theater has been vacated, an employee of the theater can actuate a single remote control device which wirelessly transmits a command to all seats in a given theater. Upon receiving said command from the remote control device, the wireless communications module will send a signal to the microcontroller. The microcontroller in turn, begins a chain of events which cause a signal to be sent to said electrical control circuit energizing the linear actuator and causing the chair to return to its closed position. In the preferred embodiment the microcontroller activates two MOSFETs which in-turn activate two relays causing electricity to flow through the linear actuator in the proper direction. Other possible methods may include but are not limited to, the use of an h-bridge circuit comprised of solid-state switching devices, a motor driver, or other electrical switching device.

A second embodiment of this invention contains three devices. The first device is substantially affixed to a chair located in a movie theater and contains a microcontroller, a wireless communication device, a human interface device, preferably a button, and a device capable of providing adequate power for the necessary functions to be performed. In this embodiment a small transformer, sometimes referred to as a “wall wart” is used, but any power supply is acceptable, especially a battery. The second device contains a wireless communication module, a microcontroller, and a device capable of providing adequate power for the necessary functions to be performed. In this embodiment a small transformer, sometimes referred to as a “wall wart” is used, but any power supply is acceptable, especially a battery. The second device may be a custom designed wireless communication module, a WIFI hotspot, Blue Tooth, device, Zigbee device, or any commonly available wireless communication device. The third device is a remotely located display which may consist of any display device, preferably a desktop, laptop, tablet or other type of computer screen, but could be as simple as an LED. In this embodiment, a patron may actuate a button, touch sensor or other human input device which is detected by the microcontroller. The microcontroller then sends a signal to a wireless communication module the signal is then communicated to a remotely located unit. The signal upon arriving at the remote control unit either directly communicates that the patron in a specific chair has requested service, or communicates the same to a remote display using methods familiar to one skilled in computer programming.

A third embodiment of this device is similar to the second and consists of three devices. The first device is substantially affixed to an electrically reclining chair located in a movie theater and contains a microcontroller, a wireless communication module, a human interface device, preferably a touchscreen, and a device capable of providing adequate power for the necessary functions to be performed. In this embodiment a small transformer, sometimes referred to as a “wall wart” is used, but any power supply is acceptable, especially a battery. The second device contains a wireless communication module, a microcontroller, and a device capable of providing adequate power for the necessary functions to be performed. In this embodiment a small transformer, sometimes referred to as a “wall wart” is used, but any power supply is acceptable, especially a battery. The second device may be a custom designed wireless communication module, a WIFI hotspot, Blue Tooth, device, Zigbee device, or any commonly available wireless communication device. The third device is a display which can consist of any display device, preferably a desktop, laptop, tablet or other type of computer screen. In this embodiment, a patron may communicate through a touchscreen that he or she wishes to receive service or to receive a specific item, such as popcorn, candy, soda pop, or any other tangible good. The microcontroller then sends a signal to the wireless communication module the signal is then communicated through a Wireless Local Area Network, or some other information sharing network. The signal upon arriving at the remote control unit either directly communicates that the patron in a specific chair has requested a specific item or items and/or service, or communicates the same to a remote display using methods familiar to one skilled in computer programming.

A forth embodiment of this device is similar to the third and contains three devices. The first device is substantially affixed to an electrically reclining chair located in a movie theater and contains a microcontroller, a wireless communication module, a human interface device, preferably a touchscreen, a means of accepting payment, and a device capable of providing adequate power for the necessary functions to be performed. In this embodiment a small transformer, sometimes referred to as a “wall wart” is used, but any power supply is acceptable, especially a battery. The second device contains a wireless communication module, a microcontroller, and a device capable of providing adequate power for the necessary functions to be performed. In this embodiment a small transformer, sometimes referred to as a “wall wart” is used, but any power supply is acceptable, especially a battery. The second device may be a custom designed wireless communication module, a WIFI hotspot, Blue Tooth, device, Zigbee device, or any commonly available wireless communication device. The third device is a display which can consist of any display device, preferably a desktop, laptop, tablet or other type of screen. In this embodiment, a person associated with said chair may communicate through a touchscreen or other device that he or she wishes to receive service or to receive a specific item, such as popcorn, candy, soda pop, or any other tangible good, and upon selecting the goods he or she wishes to order, submits payment for said ordered goods. In this embodiment the patron may swipe a credit or debit card, or enter payment details using a familiar web based payment system such as PayPal. The microcontroller then sends a signal to the wireless communication module which is then communicated to the second device through a Wireless Local Area Network, or some other wireless information sharing network. Upon the signal reaching the second device, the second device verifies the legitimacy of the payment through means familiar to one skilled in computer programming and either directly communicates, to a display through methods familiar to one skilled in computer programming, that the patron in a specific chair has requested a specific item or items and/or service and has tendered payment for said item or items, if applicable, or in the event that said payment fails verification, the system communicates to the patron requesting goods, through the same wireless information network, that the payment has been declined.

A fifth embodiment comprises all of the functionality of the first and second embodiment enabling a set of devices to both wirelessly control the mechanical actuation device of the chair and wirelessly request service be provided to the patron.

A sixth embodiment comprises all of the functionality of the first and the third embodiment enabling a set of devices to both wirelessly control the mechanical actuation device of the chair and wirelessly communicate a request for a specific item or items and/or service be provided to the patron.

A seventh embodiment comprises all of the functionality of the first and the fourth embodiment enabling a set of devices to wirelessly control the mechanical actuation device of the chair, wirelessly communicate a request for a specific item or items and/or service be provided to the patron, accept payment for said specific item or items or service, and verify acceptance of said payment.

### BRIEF DESCRIPTION OF THE DRAWINGS

FIG. 1 is an exploded view of a user interface and/or control device in accordance with an embodiment of the present invention.

FIG. 2 is an exploded view of a user interface and/or control device to be substantially affixed to a chair in accordance with an embodiment of the present invention.

FIG. 3 is a cut away perspective view of two user interface and/or control devices, a remote control unit, and a mechanical actuation device substantially affixed to a chair in accordance with an embodiment of the present invention illustrating some or all of the components of the system.

FIG. 4 is an exploded view of a seat control device in accordance with an embodiment of the present invention.

FIG. 5 is a flow chart showing the general steps for operating a system in accordance with an embodiment of the present invention.

FIG. 6 is a flow chart showing the general steps for operating a system in accordance with an embodiment of the present invention.

FIG. 7 is a flow chart showing the general steps for operating a system in accordance with an embodiment of the present invention.

FIG. 8 is a flow chart showing the general steps for operating a system in accordance with an embodiment of the present invention.

FIG. 9 is a perspective view of a seat control device in accordance with an embodiment of the present invention.

FIG. 10 is a perspective view of a seat control device in accordance with an embodiment of the present invention.

FIG. 11 is a perspective view of a seat control device in accordance with an embodiment of the present invention.

### DESCRIPTION OF THE CURRENT EMBODIMENT

Overview.

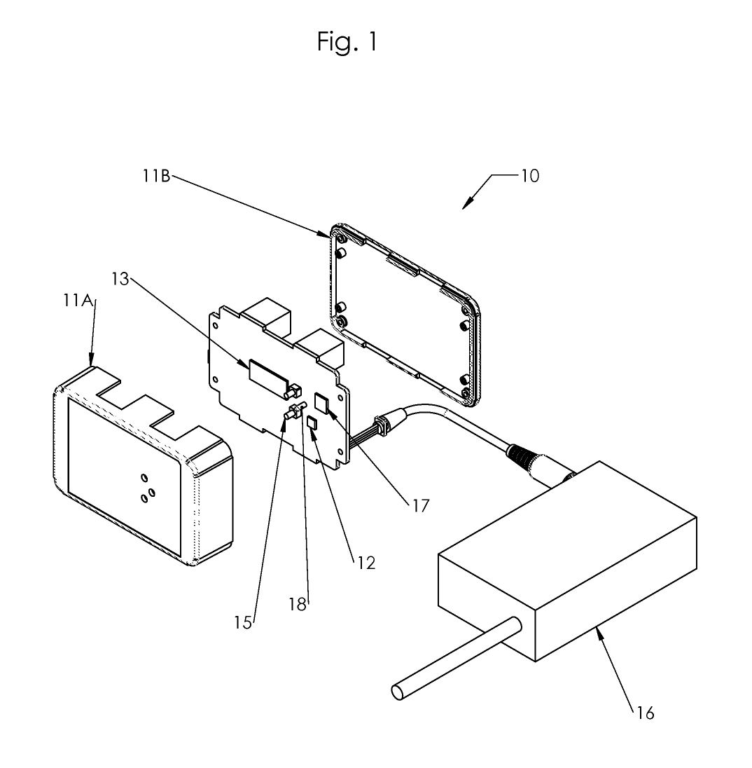

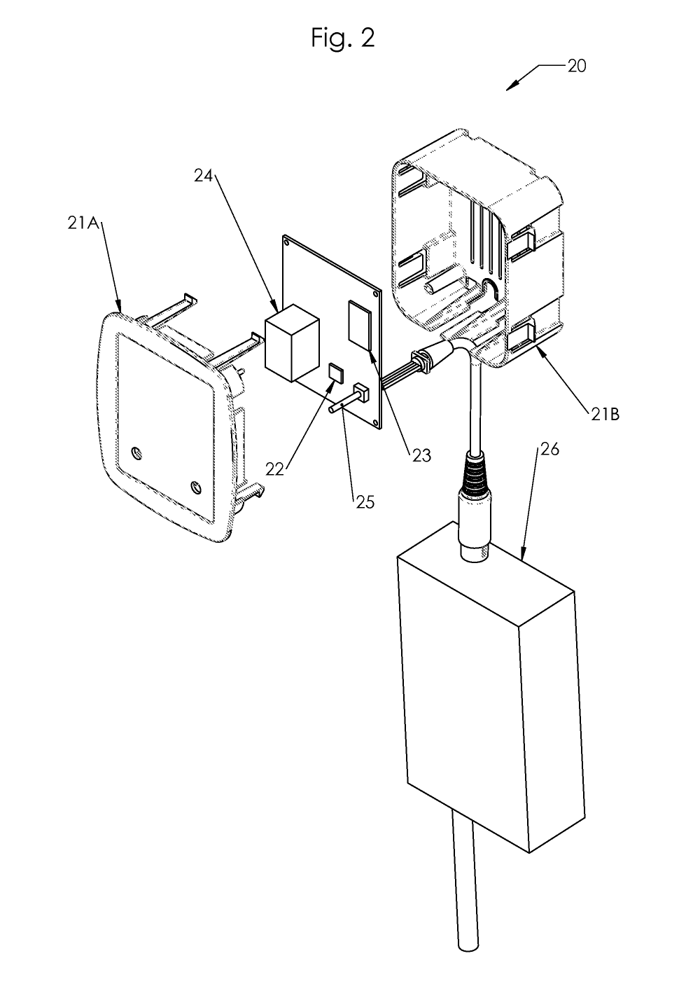

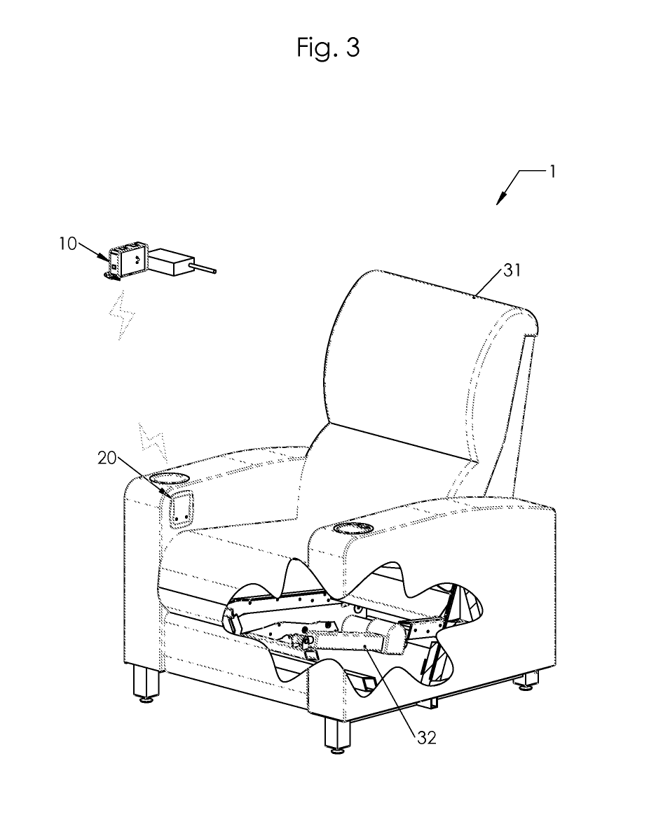

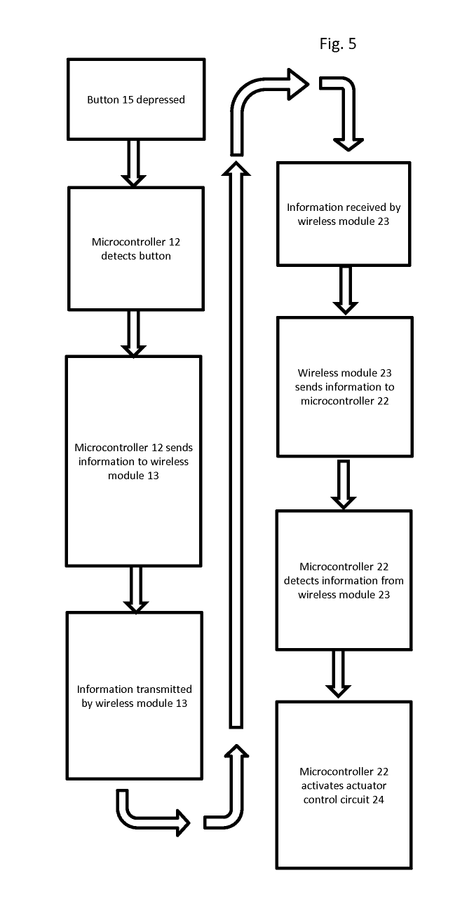

A theater chair control (TCC) system 1 in accordance with an embodiment of the present invention is shown in in FIGS. 1, 2, 3, and 5. In this embodiment the TCC system 1 includes a device 10 containing a two piece housing 11A and 11B, a microcontroller 12, a wireless communication module 13, a user input device configured as a button 15, a power supply and cord 16, and includes one or more chairs 31, one or more devices 20 containing a two piece housing 21A and 21B, a microcontroller 22, a wireless communication module 23, a linear actuator control circuit 24, and a power supply and cord 26. When user input device 15 is actuated, the actuation is detected by microcontroller 12, a signal is transmitted to wireless module 13, wireless module 13 sends a wireless signal to wireless module 23 which is detected by microcontroller 22. Microcontroller 22 actuates linear actuator control circuit 24 returning the linear actuator 32 and chair 31 to a predetermined position.

TCC system 1 may be used for a variety of purposes. For example, TCC system 1 may be activated to return all chairs within a movie theater to a closed position to arrange the theater in such a manner as to present all incoming patrons with a fully upright chair for ease of entry. As another example TCC system 1 may be activated to move all chairs within a movie theater to a fully reclined or open position to more easily allow cleaning under the chairs or in areas of the chairs only exposed when the chair is in a reclined position.

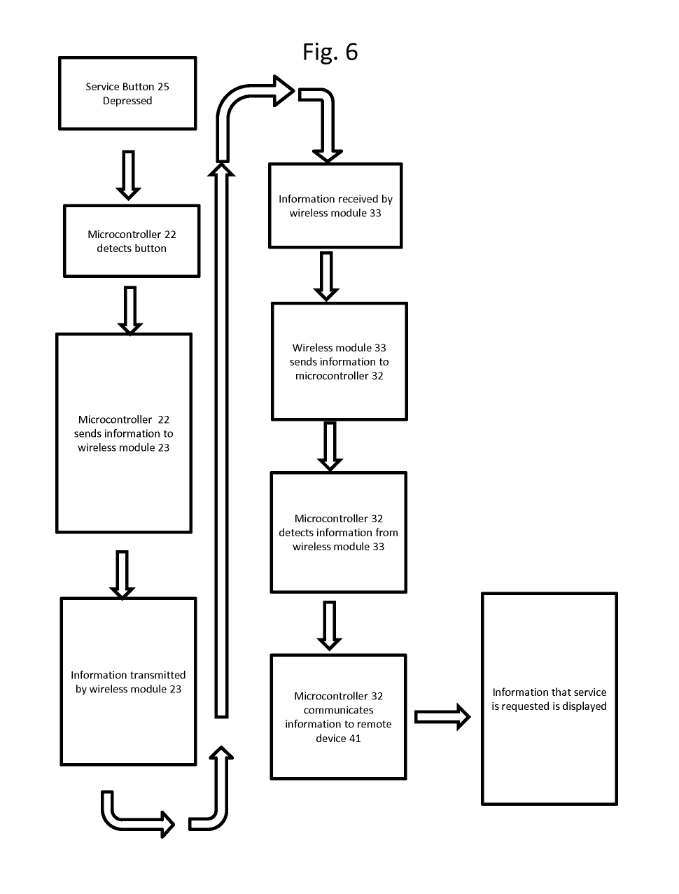

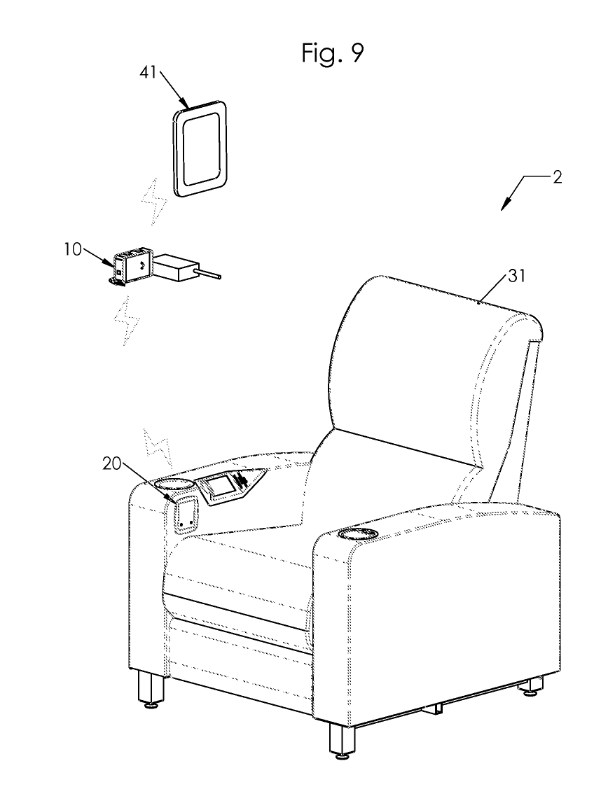

A theater chair control (TCC) system 2 in accordance with an embodiment of the present invention is show in in FIGS. 1, 2, 6, and 9. In this embodiment the TCC system 2 includes one or more chairs 31, one or more devices 20 containing a two piece housing 21A and 21B, a microcontroller 22, a wireless communication module 23, a user input device configured as a button 25, and a power supply and cord 26; and a device 10 containing a two piece housing 11A and 11B, a microcontroller 12, a wireless communication module 13, network communication device 17, and a power supply and cord 16. When user input device 25 is actuated, the actuation is detected by microcontroller 22, a signal containing information that an event has occurred and information identifying the transmitting device is transmitted to wireless module 23, wireless module 23 sends a wireless signal to wireless module 13 which is detected by microcontroller 12. Microcontroller 12 may actuate a display 18 which indicates that button 25 was activated, or may activate network communication device 17 which communicates to a remote device 41 that button 25 has been activated.

TCC system 2 may be used for a variety of purposes. For example, TCC system 2 may be activated to request that service be provided to the location of Device 20. The operator of device 20 may summon a server to take an order for food or beverage, or other item. The operator of device 20 may also summon a server to request a bill for items provided, or may summon a server or other person for any reason.

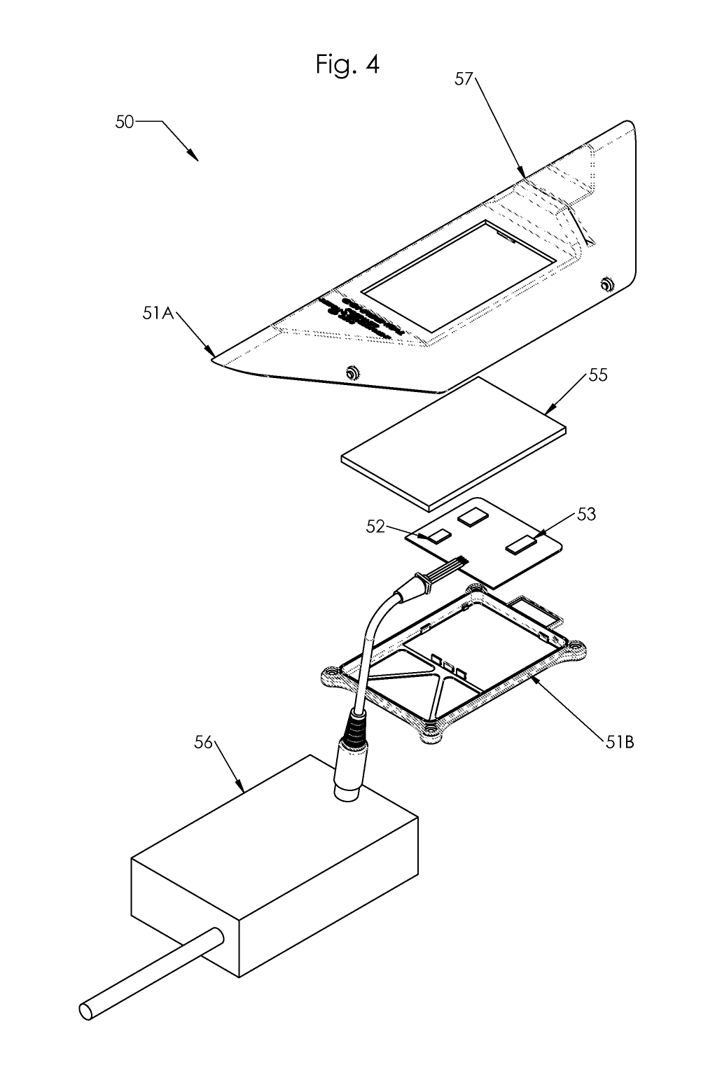

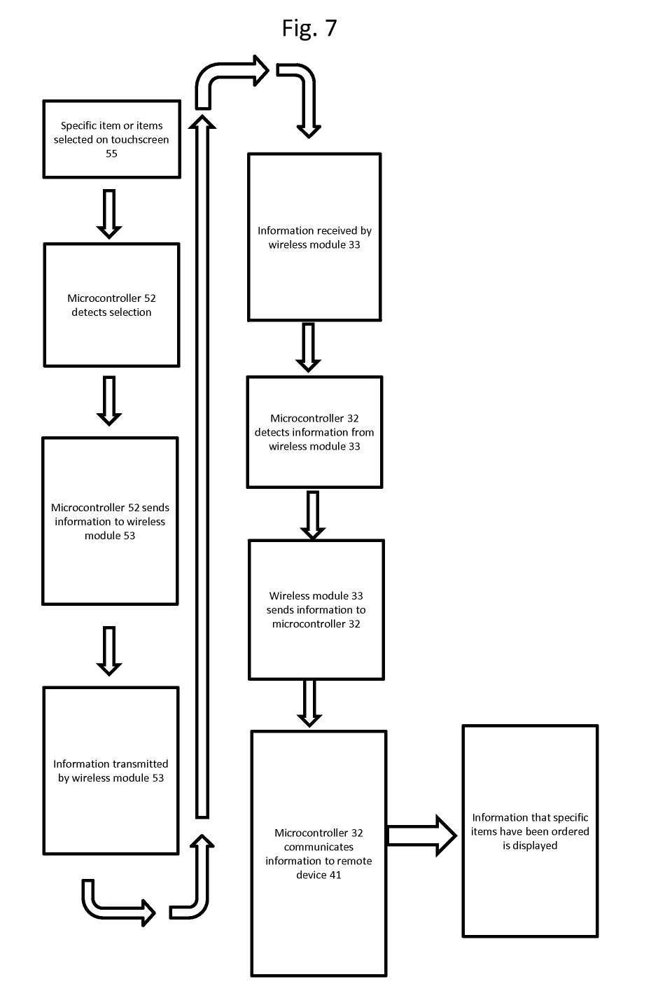

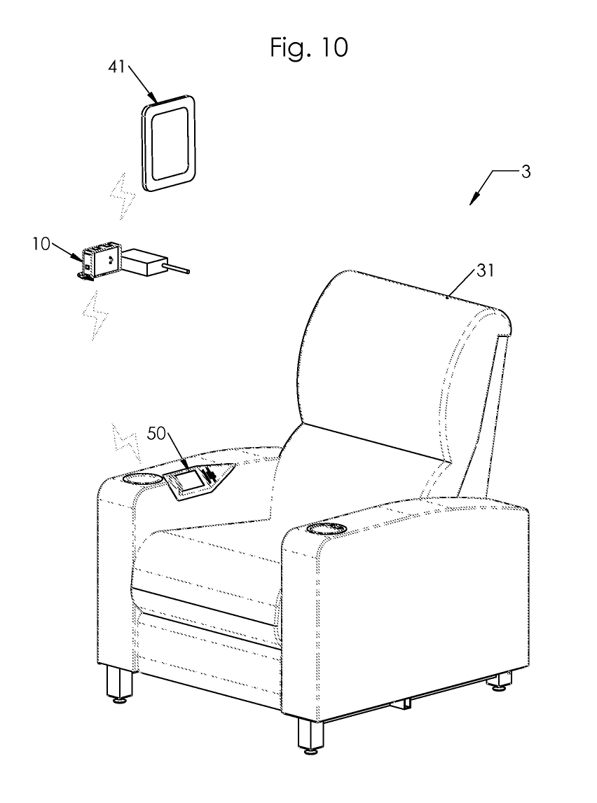

A theater chair control (TCC) system 3 in accordance with an embodiment of the present invention is shown in in FIGS. 1, 4, 7 and 10. In this embodiment the TCC system 3 includes one or more chairs 31, one or more devices 50 containing a two piece housing 51A and 51B, a microcontroller 52, a wireless communication module 53, a combined display and user input device configured as a touchscreen 55, a power supply and cord 56; and a device 10 containing a two piece housing 11A and 11B, a microcontroller 12, a wireless communication module 13, and a power supply and cord 16. When user input device 55 is actuated, the actuation is detected by microcontroller 52, a signal containing information that an event has occurred, information necessary to fulfill the requirements of the event, and information identifying the transmitting device is transmitted to wireless module 53, wireless module 53 sends a wireless signal to wireless module 13 which is detected by microcontroller 12. Microcontroller 12 may activate network communication device 17 which communicates to a remote device 41 that a certain item or items and/or service has been requested using touchscreen 55.

TCC system 3 may be used for a variety of purposes. For example, TCC system 3 may be activated to request that popcorn be provided to the location of device 50. The operator of device 50 may place an order for or summon a server to take an order for food or beverage, or other item, to request a bill for items provided, to request cleanup of a spilled beverage or other person for any reason.

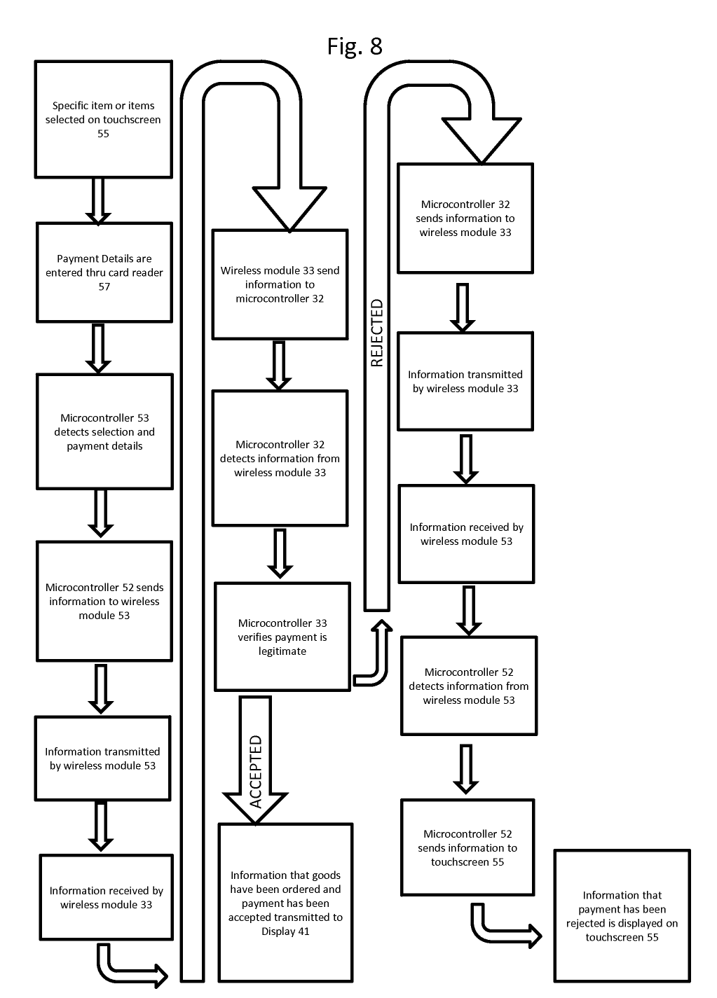

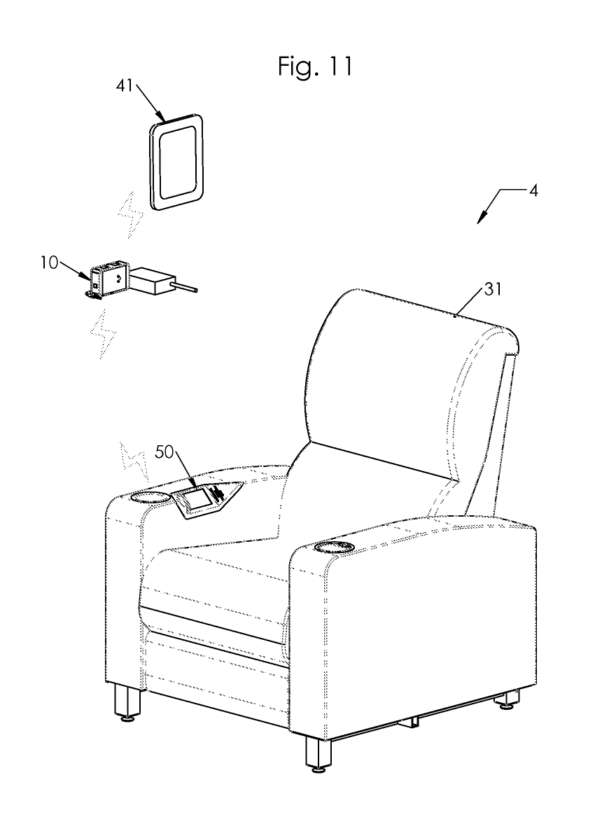

A theater chair control (TCC) system 4 in accordance with an embodiment of the present invention is shown in FIGS. 1, 4, 8, and 11. In this embodiment the TCC system 4 includes one or more chairs 31, one or more devices 50 containing a two piece housing 51A and 51B, a microcontroller 52, a wireless communication module 53, a combined display and user input device configured as a touchscreen 55, a card reading device 57, a power supply and cord 56, and a device 10 containing a two piece housing 11A and 11B, a microcontroller 12, a wireless communication module 13, and a power supply and cord 16. When user input device 55 is actuated and payment is tendered using card reader 57, the actuation is detected by microcontroller 52, a signal containing information that an event has occurred, information necessary to fulfill the requirements of the event, information necessary to verify and process payment related to said event, and information identifying the transmitting device is sent to wireless module 53, wireless module 53 sends a wireless signal to wireless module 13 which is detected by microcontroller 12. Microcontroller 12 may activate network communication device 17 to verify, through standard methods that payment has been accepted, then communicates to a remote device 41 that a certain item or items and/or service has been requested using touchscreen 55, or communicates to the operator of device 55 that payment has been rejected.

TCC system 4 may be used for a variety of purposes. For example, TCC system 4 may be activated to request that popcorn be provided to the location of device 50. The operator of device 50 may place an order for, or summon a server to take an order for food or beverage, or other item or tender payment. The operator of device 50 may also summon a server to request a bill for items provided, or may summon a server or other person for any reason.

The above descriptions are those of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A system for remotely controlling one or more mechanical functions of chairs comprising two or more devices in wireless communication, the first device containing a one or more microcontrollers or microprocessors, one or more means for establishing wireless communication, one or more control circuits suitable for controlling one or more mechanical actuation devices, a method of wirelessly coupling the first device to the second and one or more devices capable of providing adequate power for the necessary functions to be performed, the second device containing one or more devices means for establishing wireless communication, one or more microcontrollers or microprocessors, one or more means of receiving an input from an outside entity, either a human, timer, computer program, or other device capable of initiating an event, and one or more devices capable of providing adequate power for the necessary functions to be performed, whereby an input to the second device, through direct or indirect wireless communications causes the first device to activate said mechanical functions.

2. The system of claim 1 further comprising a system for communicating the desire of an occupant of a chair to receive a service or services and/or a good or goods comprising two or more devices, the first device being substantially affixed to said chair, containing one or more microcontrollers or microprocessors, one or more means for establishing wireless communication, one or more human interface devices, and one or more devices capable of providing adequate power for the necessary functions to be performed, the second device containing one or more means for establishing wireless communication, one or more microcontrollers or microprocessors, one or more displays adequate for communicating that a patron has activated device one, one or more methods of providing adequate power for the necessary functions to be performed, whereby an input to the first device is directly or indirectly wirelessly communicated to the second device and is communicated by the second device directly or indirectly to a display in such a manner as to attract the attention of a party who may fulfill requests of said requestor.

3. The system of claim 2 further comprising a system for communicating a list or graphic display of a service or services and/or good or goods available for purchase to the occupant of a chair and communicating the desire of said occupant to receive a specific service or services and/or good or goods comprising two or more devices, the first device being substantially affixed to said chair, containing one or more microcontrollers or microprocessors, one or more wireless communication devices, one or more human interface devices, and one or more devices capable of providing adequate power for the necessary functions to be performed, the second device containing one or more means for establishing wireless communication, one or more microcontrollers or microprocessors, one or more displays adequate for communicating that a patron has activated device one, and one or more methods of providing adequate power for the necessary functions to be performed, whereby any number of specific inputs to the first device can be directly or indirectly wirelessly communicated to a second device and directly or indirectly be displayed in such a manner as to attract the attention of a party who may provide the specifically requested goods or service to the said occupant of chair.

4. The system of claim 3 further including one or more methods for tendering payment and relaying payment information for said items.

5. A system for communicating the desire of an occupant of a chair to receive a service or services and/or a good or goods comprising two or more devices, the first device being substantially affixed to said chair, containing one or more microcontrollers or microprocessors, one or more means for establishing wireless communication, one or more human interface devices, and one or more devices capable of providing adequate power for the necessary functions to be performed, the second device containing one or more means for establishing wireless communication, one or more microcontrollers or microprocessors, one or more displays adequate for communicating that a patron has activated device one, one or more methods of providing adequate power for the necessary functions to be performed, whereby an input to the first device is directly or indirectly wirelessly communicated to the second device and is communicated by the second device directly or indirectly to a display in such a manner as to attract the attention of a party who may fulfill requests of said requestor.

6. The system of claim 5 further comprising a system for communicating a list or graphic display of a service or services and/or good or goods available for purchase to the occupant of a chair and communicating the desire of said occupant to receive a specific service or services and/or good or goods comprising two or more devices, the first device being substantially affixed to said chair, containing one or more microcontrollers or microprocessors, one or more wireless communication devices, one or more human interface devices, and one or more devices capable of providing adequate power for the necessary functions to be performed, the second device containing one or more means for establishing wireless communication, one or more microcontrollers or microprocessors, one or more displays adequate for communicating that a patron has activated device one, and one or more methods of providing adequate power for the necessary functions to be performed, whereby any number of specific inputs to the first device can be directly or indirectly wirelessly communicated to a second device and directly or indirectly be displayed in such a manner as to attract the attention of a party who may provide the specifically requested goods or service to the said occupant of chair.

7. The system of claim 6 further including one or more methods for tendering payment and relaying payment information for said items.

8. A system for communicating a list or graphic display of a service or services and/or good or goods available for purchase to the occupant of a chair and communicating the desire of said occupant to receive a specific service or services and/or good or goods comprising two or more devices, the first device being substantially affixed to said chair, containing one or more microcontrollers or microprocessors, one or more wireless communication devices, one or more human interface devices, and one or more devices capable of providing adequate power for the necessary functions to be performed, the second device containing one or more means for establishing wireless communication, one or more microcontrollers or microprocessors, one or more displays adequate for communicating that a patron has activated device one, and one or more methods of providing adequate power for the necessary functions to be performed, whereby any number of specific inputs to the first device can be directly or indirectly wirelessly communicated to a second device and directly or indirectly be displayed in such a manner as to attract the attention of a party who may provide the specifically requested goods or service to the said occupant of chair.

9. The system of claim 8 further including one or more methods for tendering payment and relaying payment information for said items.
